(19) United States
(12) Patent Application Publication
(10) Pub. No.: US 2026/0157413 A1
(43) Pub. Date: Jun. 11, 2026

(54) Methods and Kits for Wrapping and Transporting a Handroll

(71) Applicant: Jomasa LLC, New York, NY (US)

(72) Inventors: Kevin Kim, New York, NY (US); Masashi Ito, Jersey City, NJ (US)

(73) Assignee: Jomasa LLC, New York, NY (US)

(21) Appl. No.: 18/977,599

(22) Filed: Dec. 11, 2024

(51) Int. Cl. A23P 20/20; B65D 65/10; B65D 65/22

(52) U.S. Cl. CPC A23P 20/20; B65D 65/10; B65D 65/22

(57) ABSTRACT

A method and a kit for wrapping a handroll is disclosed. The kit includes a wrapping made of a flexible product or film and having a pouch portion, a sheet for enclosing the ingredients of the handroll and one or more ingredients of the handroll. In the method, the sheet and ingredients are provided in a wrapping in a circularly wrapped configuration, where a first end of the sheet is held within the pouch portion and the first end of the sheet does not contact the ingredients. The wrapping is unwrapped such that the ingredients are on top of a second end of the sheet. The sheet is then rotated around the ingredients from the second end of the sheet toward the first end of sheet while extracting the first end from the pouch portion until the sheet fully encompasses the and forms the handroll.

### TECHNICAL FIELD

The present application relates to methods and kits for handrolls or temaki, and in particular, methods and kits for wrapping and transporting handrolls or temaki.

### BACKGROUND

Handrolls or temaki are a very popular variety of sushi. Temaki has conventionally been enjoyed in restaurants or when prepared at home.

In recent years there has been an increased demand for takeout or delivery options for temaki. However, because of the amount of time between preparation of the temaki and consumption of the temaki by the customer after delivery or after pick-up of the food from the restaurant, the sheet of the temaki (e.g., seaweed) can become soggy or mushy before the customer has an opportunity to consume it.

The present application addresses these and other issues related to temaki or handroll sushi, and the ability to maintain freshness before consumption.

### SUMMARY

In a first aspect, a method for wrapping a handroll is provided. In the method a sheet and ingredients for a handroll are provided in a wrapping. The wrapping comprises a free end and a pouch portion having two overlapping layers, where a first end of the sheet is held within the pouch portion and a second end of the sheet is placed on top of the free end of the wrapping. The ingredients are placed on top of the sheet at the free end of the wrapping, and the wrapping is wrapped around the sheet and the ingredients in a circular fashion such that the first end of the sheet remains within the pouch portion and does not contact the ingredients. The wrapping is then unwrapped such that the ingredients are on top of the second end of the sheet. The sheet is then rotated around the ingredients from the second end of the sheet toward the first end of sheet while the first end of the sheet is extracted from the pouch portion until the sheet fully encompasses the ingredients and the first end of the sheet is removed from the pouch portion, thereby forming the handroll.

In another aspect, the step of rotating the sheet further comprises holding down the pouch portion of the wrapping.

In another aspect, the sheet comprises seaweed, soy paper, a cucumber wrap, or a shiso leave wrap.

In another aspect, the ingredients include one or more of rice, vegetables, a protein-based ingredient, sesame seeds, sauce, gobo, cream cheese, and avocado. In a further aspect, the protein-based ingredient is selected from the group consisting of fish, crustaceans, and tofu.

In another aspect, the wrapping is rectangular and the sheet is in the form of a rectangular sheet.

In another aspect, the wrapping is comprised of cellophane, one or more plastics, or one or more polymers, or a combination thereof.

In a second aspect, a kit for transporting and wrapping the components of a handroll is provided. The kit comprises a wrapping made of a flexible product or film, the wrapping having a pouch portion on a first end and free portion on a second end, wherein the pouch portion is comprised of two overlapping layers of the flexible product or film. The kit further includes a sheet for enclosing the ingredients of the handroll, wherein the sheet is made of an edible food product and wherein a first end of the sheet is sized to fit within the pouch portion of the wrapping. The kit also includes one or more ingredients of the handroll.

In another aspect, the kit is in a wrapped configuration such that the first end of the sheet is held within the pouch portion and a second end of the sheet is placed on top of the free end of the wrapping. The ingredients are placed on top of the sheet at the second end of the wrapping, and the wrapping is wrapped around the sheet and the ingredients in a circular fashion such that the first end of the sheet remains within the pouch end and does not contact the ingredients.

In another aspect, the kit is in an unwrapped configuration such that the first end of the sheet is held within the pouch portion and a second end of the sheet is placed on top of the free end of the wrapping, and the ingredients are placed on top of the sheet at the second end of the wrapping, and the wrapping is generally in a flat arrangement.

In another aspect, the sheet of the kit comprises seaweed, soy paper, a cucumber wrap, or a shiso leave wrap.

In another aspect, the ingredients of the kit include one or more of rice, vegetables, a protein-based ingredient, sesame seeds, sauce, gobo, cream cheese, and avocado. In a further aspect, the protein-based ingredient is selected from the group consisting of fish, crustaceans, and tofu.

In another aspect, the wrapping is rectangular and the sheet is in the form of a rectangular sheet. In a further aspect, the overlapping layers of the pouch portion comprises of a rectangular top layer that overlays the first end of the wrapping such that borders on three sides of the top layer are attached to the corresponding borders of the first end of the wrapping that they overlap, thereby resulting in an opening between the top layer and the first end of the wrapping along a non-attached fourth border of the top layer.

In another aspect, the wrapping is comprised of cellophane, one or more plastics, or one or more polymers, or a combination thereof.

### BRIEF DESCRIPTION OF DRAWING FIGURES

The processes and kits of the present disclosure will be described in more detail below and with reference to the attached drawings.

FIG. 1 shows a diagram of the contents of the temaki or handroll in the wrapping in a wrapped configuration in accordance with one or more embodiments.

FIG. 2 shows a diagram of the contents of the temaki or handroll in an unwrapped configuration in accordance with one or more embodiments.

FIG. 3 shows a diagram of unwrapping the temaki or handroll contents from the wrapped configuration in accordance with one or more embodiments.

FIG. 4 shows a diagram of the contents of the temaki or handroll in an unwrapped configuration as a user begins to wrap the temaki or handroll in a sheet in accordance with one or more embodiments.

FIG. 5 shows a diagram of the wrapping of the temaki or handroll in the sheet as the sheet is extracted from the pouch of the wrapping in accordance with one or more embodiments.

FIG. 6 shows a diagram of the completed temaki or handroll after the sheet is extracted from the pouch of the wrapping in accordance with one or more embodiments.

### DETAILED DESCRIPTION

In according with one or more embodiments, the present application discloses a method for transporting and wrapping a handroll or temaki sushi. In a first aspect, a sheet (e.g., seaweed) for the temaki or handroll is provided in a wrapping with a portion of sheet being held within a pouch of the wrapping. The remaining ingredients of the temaki (e.g., rice, avocado, vegetables, protein) are located on the portion of the sheet that is not within the pouch. The wrapping is wrapped around the sheet and the ingredients in a circular fashion such that the portion of sheet in the pouch remains within the pouch, and does not contact the ingredients. In this wrapped configuration, the components of the handroll or temaki can be transported for delivery or for take-out, for example.

To prepare the temaki or handroll from the components in the wrapped configuration, the wrapping is first unwrapped such that the ingredients are located on top of the portion of the sheet that is not within the pouch. To form the handroll, the sheet is then rotated around the ingredients by rotating the sheet toward the end of the sheet that is in the pouch while simultaneously extracting the other end of the sheet from the pouch until the sheet fully encompasses the ingredients and the first end of the sheet is removed from the pouch end.

In the present method during transport of the temaki ingredients in the wrapping, half of the sheet (e.g., seaweed) of the temaki is fully covered by the pouch of the wrapping and the other ingredients are located on the exposed side of the sheet. This ensures that the half of the sheet (e.g., seaweed) that is in the pouch remains crispy during transport such that it maintains its crispy bite feel when the handroll is prepared and eaten by the customer.

Also disclosed herein is a kit for transporting and wrapping a handroll or temaki sushi. The kit includes the wrapping (e.g., plastic wrapping) having a pouch portion, the sheet (e.g., seaweed), the ingredients of the handroll (e.g., rice, avocado, vegetable, protein), and optionally a holding mechanism (e.g., adhesive or sticker) for holding all the components within the wrapping.

These and other aspects of the present methods and kits are described in further detail below.

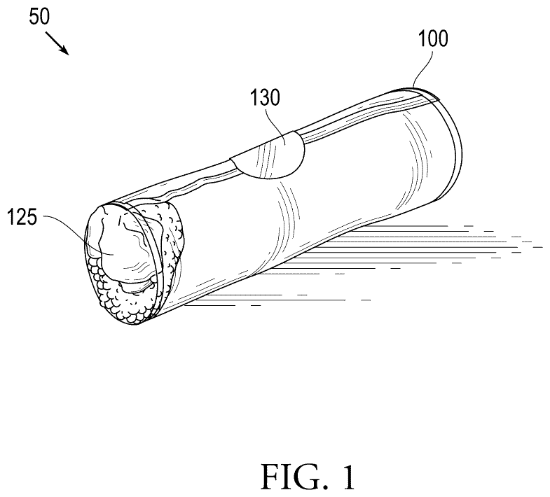

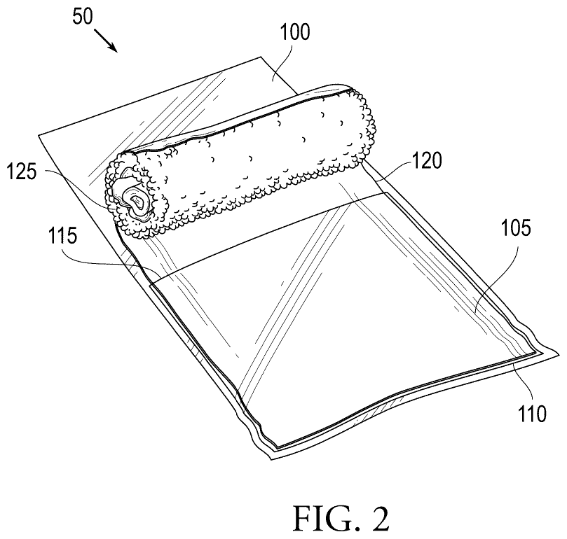

FIG. 1 shows a diagram of the contents of the temaki or handroll in the wrapping in a wrapped configuration in accordance with one or more embodiments. FIG. 2 shows a diagram of the contents of the temaki or handroll in an unwrapped configuration in accordance with one or more embodiments, such that the contents of the handroll and the wrapping are generally in a flat arrangement when placed on a flat surface, such as a table. In one or more embodiments, the contents of the temaki and the wrapping make up the kit of the present application.

With reference now to FIGS. 1 and 2, in one or more embodiments, a kit 50 comprising the components of temaki or handroll sushi and the wrapping for transport is provided. The kit includes a wrapping 100, where the wrapping 100 can be made of flexible product or film, such as cellophane, one or more plastics, or one or more polymers, or a combination thereof. In one or more embodiments, the wrapping 100 is generally rectangular in shape. The wrapping 100 includes on one end a pouch portion 105. The pouch portion 105 consists of two overlapping layers of flexible product. In particular, the pouch portion 105 consists of a top layer 110 that overlays one end of the wrapping 100, such that the borders on 3 sides of the top layer 110 are attached the corresponding borders of the wrapping 100 that they overlap, thereby resulting in an opening 115 between the top layer 110 and the rest of the wrapping 110 along the non-attached border (top end) of the top layer.

With continued reference to FIGS. 1 and 2, the kit 50 further a sheet 120 used to enclose the ingredients of the temaki or handroll. The sheet 120 is generally rectangular in shape and sized to fit within the pouch portion 105 of the wrapping 100. The sheet 120 can be made of an edible food product, such as a nori sheet (seaweed sheet). In one or more embodiments, the sheet 120 can be made of other edible food products, such as soy paper, cucumber, or shiso leaves, for example.

The kit 50 further includes ingredients 125 of the temaki or handroll. The ingredients 125 can vary depending on the type of temaki or handroll that is being prepared. In one or more embodiments, the ingredients 125 can include one or more of rice, vegetable(s), a protein-based ingredient(s) such fish, crustaceans, and tofu, sesame seeds, sauce(s), gobo, cream cheese, and avocado, for example. In one or more embodiments, the ingredients 125 of the temaki an include other food products as known and understood in the art. As exemplified in FIGS. 1 and 2, in one or more embodiment, the rice can be wrapped around a variety of other ingredients of the temaki or handroll.

As shown in FIG. 2, a first end of the sheet 120 (e.g., nori sheet) is sized and shaped to be held within the pouch portion 105 of the wrapping 100 and a second end of the sheet 120 can be placed on top of the free end of the wrapping 100. The ingredients 125 can be placed on top of the sheet at the free end of the wrapping 100.

To get the wrapping 100 into the wrapped configuration as exemplified in FIG. 1, the wrapping 100 is wrapped in a circular fashion around the sheet 120 and the ingredients 125 such that the first end of the sheet remains within the pouch portion 105 and does not contact the ingredients 125. In one or more embodiments, the wrapping 100 can be secured in the wrapped configuration via a connector 130 such as a sticker or an adhesive, for example, the holds an end of the wrapping 100 to another portion of the wrapping 100.

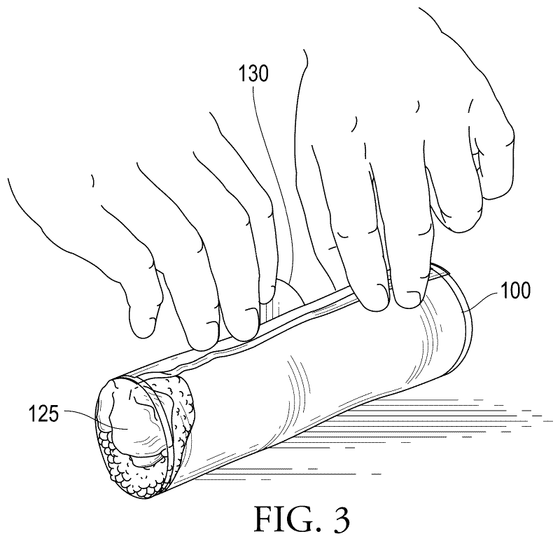

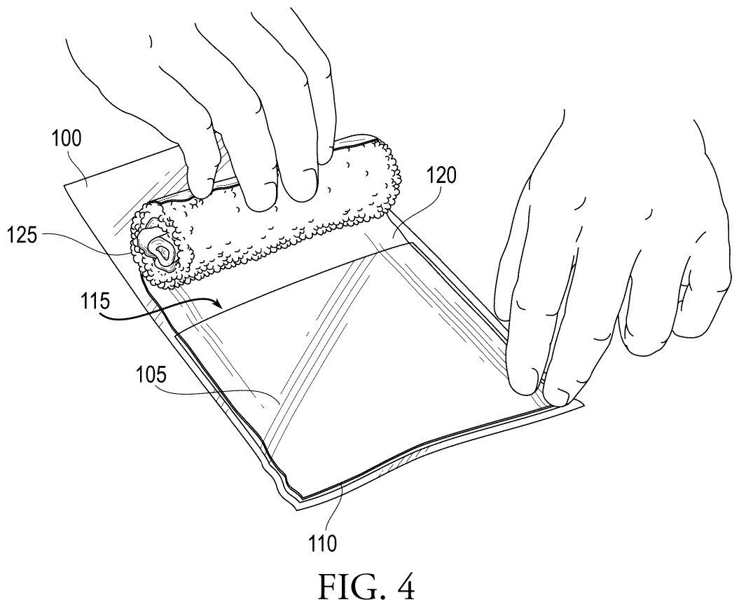

FIGS. 3-6 shows exemplary embodiments of the steps of the present method for transporting and wrapping a handroll in accordance with one or more embodiments. As exemplified in FIG. 3, the components of the temaki/handroll are provided in the wrapped configuration. In the next step, the wrapping 100 is unwrapped by, for example, pulling off the connector 130 to separate the ends of the wrapping 100, as shown in FIG. 3. As a result of unwrapping the wrapping 100, the ingredients 125 are on top of the sheet at the free end of the wrapping 100, as shown in FIG. 4.

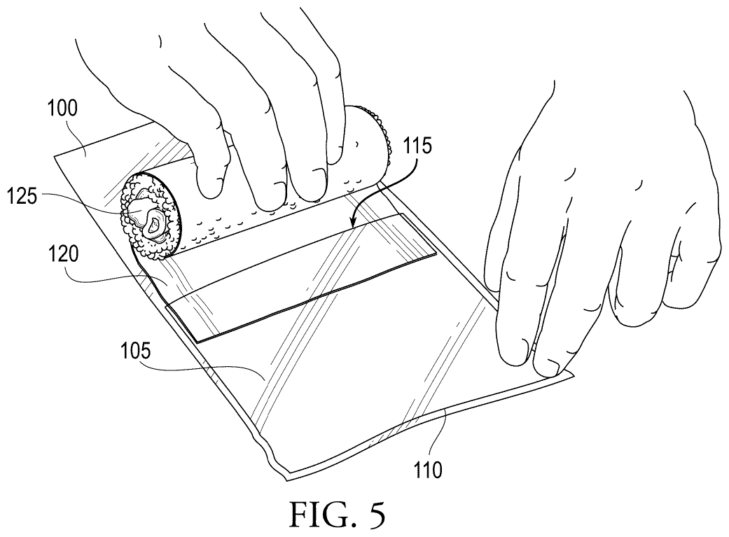

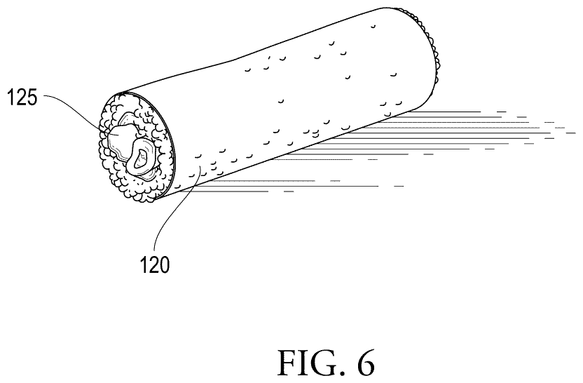

At the next steps, as exemplified in FIGS. 5-6, the sheet 120 then wrapped around the ingredients to form the handroll. Specifically, as shown in FIG. 5, the sheet 120 is wrapped around the ingredients 125 by rotating from the second end (free end) of the sheet 120 toward the first end of sheet 120 (i.e., the end held within the pouch portion 105) while extracting the first end of the sheet 120 from the pouch portion until the sheet 100 fully encompasses the ingredients 125 and the first end of the sheet 100 is removed from the pouch portion 105. In one or more embodiments, the user can extract the first end of the sheet 120 by holding down an end of the pouch portion 105 while rotating the second end (free end) of the sheet 120 toward the first end of sheet 120 as exemplified in FIG. 5.

In one or more embodiments, the method can be performed on a flat surface, such as a table, to enable wrapping of the handroll and extraction of the sheet (e.g., seaweed) from the pouch portion. After wrapping, the temaki or handroll can be sliced into one or more smaller rolls for consumption, as desired by the user.

The method and kit of the present application ensure that at least a portion sheet (e.g., seaweed) remains crispy during transport such that it maintains its crispy bite feel when the handroll is prepared and eaten by the customer. At the same time, the ingredients are already on a portion of the sheet (e.g., seaweed) during transport in order to keep the ingredients together and prevent them from falling out during transport before the customer can make the handroll. Accordingly, the present method and kit enables the components of the handroll to be securely transported before use by the customer, while still maintaining the crispy, fresh bite feel of the sheet (e.g., seaweed).

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed:

1. A method for wrapping a handroll, the method comprising:
providing a sheet and ingredients for a handroll in a wrapping, wherein the wrapping comprises a free end and a pouch portion having two overlapping layers, wherein a first end of the sheet is held within the pouch portion and a second end of the sheet is placed on top of the free end of the wrapping, wherein the ingredients are placed on top of the sheet at the free end of the wrapping, and wherein the wrapping is wrapped around the sheet and the ingredients in a circular fashion such that the first end of the sheet remains within the pouch portion and does not contact the ingredients;
unwrapping the wrapping such that the ingredients are on top of the second end of the sheet; and
rotating the sheet around the ingredients from the second end of the sheet toward the first end of sheet while extracting the first end of the sheet from the pouch portion until the sheet fully encompasses the ingredients and the first end of the sheet is removed from the pouch portion, thereby forming the handroll.

2. The method of claim 1, wherein the step of rotating the sheet further comprises holding down the pouch portion of the wrapping.

3. The method of claim 1, wherein the sheet comprises seaweed, soy paper, a cucumber wrap, or a shiso leave wrap.

4. The method of claim 1, wherein the ingredients include one or more of rice, vegetables, a protein-based ingredient, sesame seeds, sauce, gobo, cream cheese, and avocado.

5. The method of claim 4, wherein the protein-based ingredient is selected from the group consisting of fish, crustaceans, and tofu.

6. The method of claim 1, wherein the wrapping is rectangular and the sheet is in the form of a rectangular sheet.

7. The method of claim 1, wherein the wrapping is comprised of cellophane, one or more plastics, or one or more polymers, or a combination thereof.

8. A kit for transporting and wrapping the components of a handroll, the kit comprising:
a wrapping made of a flexible product or film, the wrapping having a pouch portion on a first end and free portion on a second end, wherein the pouch portion is comprised of two overlapping layers of the flexible product or film;
a sheet for enclosing the ingredients of the handroll, wherein the sheet is made of an edible food product and wherein a first end of the sheet is sized to fit within the pouch portion of the wrapping; and
one or more ingredients of the handroll.

9. The kit of claim 8, wherein the kit is in a wrapped configuration such that the first end of the sheet is held within the pouch portion and a second end of the sheet is placed on top of the free end of the wrapping, wherein the ingredients are placed on top of the sheet at the second end of the wrapping, and wherein the wrapping is wrapped around the sheet and the ingredients in a circular fashion such that the first end of the sheet remains within the pouch end and does not contact the ingredients.

10. The kit of claim 8, wherein the kit is in an unwrapped configuration such that the first end of the sheet is held within the pouch portion and a second end of the sheet is placed on top of the free end of the wrapping, and wherein the ingredients are placed on top of the sheet at the second end of the wrapping, and the wrapping is generally in a flat arrangement.

11. The kit of claim 8, wherein the sheet comprises seaweed, soy paper, a cucumber wrap, or a shiso leave wrap.

12. The kit of claim 8, wherein the ingredients include one or more of rice, vegetables, a protein-based ingredient, sesame seeds, sauce, gobo, cream cheese, and avocado.

13. The kit of claim 12, wherein the protein-based ingredient is selected from the group consisting of fish, crustaceans, and tofu.

14. The kit of claim 8, wherein the wrapping is rectangular and the sheet is in the form of a rectangular sheet.

15. The kit of claim 14, wherein the overlapping layers of the pouch portion comprises of a rectangular top layer that overlays the first end of the wrapping such that borders on three sides of the top layer are attached to the corresponding borders of the first end of the wrapping that they overlap, thereby resulting in an opening between the top layer and the first end of the wrapping along a non-attached fourth border of the top layer.

16. The kit of claim 8, wherein the wrapping is comprised of cellophane, one or more plastics, or one or more polymers, or a combination thereof.
